(19) United States
(12) Patent Application Publication
(10) Pub. No.: US 2006/0154138 A1
(43) Pub. Date: Jul. 13, 2006

(54) Nonaqueous electrolyte battery

(75) Inventors: Yoshikumi Miyamoto, Tokushima-shi (JP); Yukihiro Wataru, Kyoto-shi (JP); Wataru Hirose, Ogaki-shi (JP)

Correspondence Address: DARBY & DARBY P.C., P. O. BOX 5257, NEW YORK, NY, 10150-5257, US

(73) Assignees: Sanyo Electric Co., Ltd., Moriguchi-shi (JP); Sanyo GS Soft Energy Co., Ltd., Kyoto-shi (JP)

(21) Appl. No.: 11/329,507

(22) Filed: Jan. 10, 2006

(30) Foreign Application Priority Data
Jan. 12, 2005 (JP) 2005-005681

(51) Int. Cl. H01M 2/18

(52) U.S. Cl. 429/130; 429/94; 429/144

(57) ABSTRACT

A nonaqueous electrolyte battery wherein a power generating element formed by spirally winding a positive electrode plate and a negative electrode plate with a separator insulated therebetween, is accommodated in a case. Insulating tapes are adhered to end faces of the power generating element and to portions of side faces of the power generating element in the vicinities of the end faces along the winding direction of the positive electrode plate and the negative electrode plate. With this configuration, the insulating tapes are not deformed at the time when the power generating element is inserted into the case. Hence, it is possible to securely prevent a short circuit between the end faces of the power generating element and the inner faces of the case, and the permeability of the electrolytic solution is improved.

### CROSS-REFERENCE TO RELATED APPLICATIONS

This Nonprovisional application claims priority under 35 U.S.C. § 119(a) on Patent Application No. 2005-005681 filed in Japan on Jan. 12, 2005, the entire contents of which are hereby incorporated by reference.

### BACKGROUND OF THE INVENTION

1. Field of the Invention

The present invention relates to a nonaqueous electrolyte battery in which a power generating element formed by spirally winding a positive electrode plate and a negative electrode plate with a separator insulated therebetween, is accommodated in an outer package.

2. Description of Related Art

A nonaqueous electrolyte battery, such as a lithium-ion rechargeable battery, has a constitution wherein a power generating element formed by spirally winding sheet-shaped or foil-shaped positive and negative electrode plates with a separator insulated therebetween, for example, is accommodated in an aluminum case serving as an outer package, for example, or has a constitution wherein a laminated film serving as an outer package is wound around the whole of the power generating element. At each end face of the power generating element configured as described above, the end faces of the positive electrode plate, the negative electrode plate and the separator are exposed. Hence, in the case that the separator shrinks under high temperature environment, the end faces of the positive electrode plate and the negative electrode plate protrude from the end face of the separator, and there is a fear of causing a short circuit between the positive electrode plate and the negative electrode plate via the inner face of the case or they directly contact with each other. For the purpose of avoiding this kind of fear, a countermeasure wherein an insulating tape is adhered around the circumstance of the end face of the power generating element is generally taken conventionally. As a specific example, Japanese Patent Application Laid-Open No. 2004-30938 discloses a configuration wherein an insulating tape is adhered to the end portion of the side face of the power generating element so as to protrude from the end face thereof.

However, in the case that the insulating tape is adhered to the end portion of the side face of the power generating element so as to protrude from the end face thereof as described above, there is a possibility that the insulating tape may make contact with the case serving as an outer package and may be deformed at the time when the power generating element is inserted into the case so as to be accommodated therein. As a result, the insulation between the end face of the power generating element and the inner face of the outer package cannot be insured occasionally depending on the state and degree of the deformation of the insulating tape, and there is a problem of causing unstable insulation. In addition, there is a possibility that the insulating tape may be adhered to the outer package at the time when the power generating element is inserted into the outer package. Furthermore, in a state wherein the insulating tape is adhered to the end face of the power generating element, there is a problem of lowering the permeability of the electrolytic solution.

### BRIEF SUMMARY OF THE INVENTION

In consideration of the circumstances described above, an object of the present invention is to provide a nonaqueous electrolyte battery, in which insulating tapes are not deformed at the time when a power generating element is inserted into an outer package so as to be accommodated therein, thereby being capable of securely preventing a short circuit between a positive electrode plate and a negative electrode plate owing to the contact between the end face of the power generating element and the inner face of the outer package. For the purpose of attaining this object, the nonaqueous electrolyte battery in accordance with the present invention is configured that, along the winding direction of the positive electrode plate and the negative electrode plate, insulating tapes are adhered to the end faces of the power generating element and to the portions of the side faces of the power generating element in the vicinities of the end faces.

In addition, another object of the present invention is to provide a nonaqueous electrolyte battery, whose permeability of the electrolytic solution thereof is improved. For the purpose of attaining this object, the nonaqueous electrolyte battery in accordance with the present invention is configured that the end face of the power generating element is not covered completely with the insulating tape but is provided with a portion to which the insulating tape is not adhered.

Furthermore, still another object of the present invention is to provide a nonaqueous electrolyte battery capable of improving the efficiency of the work for pouring the electrolytic solution while preventing a short circuit between the positive electrode plate and the negative electrode plate by avoiding the contact between the end face of the positive electrode plate and the outer package. For the purpose of attaining this object, the nonaqueous electrolyte battery in accordance with the present invention is configured that the portion inside the outer package, being opposed to the insulating tape adhered to the power generating element, is also provided with an insulating material.

Moreover, yet still another object of the present invention is to provide a nonaqueous electrolyte battery capable of allowing the power generating element to which the insulating tapes are adhered to be inserted into the outer package efficiently. For the purpose of attaining this object, the nonaqueous electrolyte battery in accordance with the present invention is configured that the thickness of the adhesive layer of the insulating tape is 10 μm or less and that the total thickness of the insulating tape is 15 μm or more and 30 μm or less.

Besides, a further object of the present invention is to provide a nonaqueous electrolyte battery capable of allowing the insulating tapes to be adhered easily to the power generating element. For the purpose of attaining this object, the nonaqueous electrolyte battery in accordance with the present invention is configured that two insulating tapes are adhered so as to be opposed to each other with the end face of the power generating element being held therebetween.

Still more, a still further object of the present invention is to provide a nonaqueous electrolyte battery capable of suppressing a short circuit between the positive electrode plate and the negative electrode plate by preventing a contact between the end face of the power generating element and the outer package under high temperature environment. For the purpose of attaining this object, the nonaqueous electrolyte battery in accordance with the present invention is configured that the degree of thermal shrinkage of the insulating tape is made smaller than the degree of thermal shrinkage of the separator.

Still further, a yet still further object of the present invention is to provide a nonaqueous electrolyte battery capable of suppressing a short circuit between the positive electrode plate and the negative electrode plate by preventing a contact between the end face of the power generating element and the outer package owing to the shrinkage of the insulating tape under high temperature environment. For the purpose of attaining this object, the nonaqueous electrolyte battery in accordance with the present invention is configured that a thermally activated adhesive layer that develops adhesiveness at a predetermined temperature or more is provided on the face of the base material of the insulating tape, the face being opposite to the face on which the adhesive layer is provided.

Additionally, a more further object of the present invention is to provide a nonaqueous electrolyte battery capable of allowing the workability of battery assembly to be improved. For the purpose of attaining this object, the nonaqueous electrolyte battery in accordance with the present invention is configured that the power generating element is accommodated in the outer package in a state that the end faces of the power generating element are opposed to the side walls of the outer package.

A first aspect of a nonaqueous electrolyte battery in accordance with the present invention is a nonaqueous electrolyte battery comprising a power generating element formed by spirally winding a positive electrode plate and a negative electrode plate with a separator insulated therebetween, and an outer package for accommodating the power generating element, and is characterized in that, along the winding direction of the positive electrode plate and the negative electrode plate, insulating tapes are adhered to the end faces of the power generating element and to the side faces of the power generating element in the vicinities of the end faces.

In the first aspect of the present invention described above, any contacts between the end faces of the power generating element and the inner face of the outer package are prevented using the insulating tapes that are adhered, along the winding direction of the positive and negative electrode plates, to the end faces of the power generating element and to the portions of the side faces of the power generating element in the vicinities of the end faces thereof. Since each of the insulating tapes is adhered to both the end face and the side face of the power generating element, the insulating tape is not deformed at the time when the power generating element is inserted into the outer package so as to be accommodated therein. For this reason, the insulation between the end face of the power generating element and the inner face of the outer package can be maintained stably, and the insulating tape is prevented from being deformed and from being adhered to the outer package. Hence, the efficiency of the work for inserting the power generating element into the outer package is thus improved. Furthermore, since the insulating tapes are adhered along the winding direction of the positive and negative electrode plates, and the end portion of the insulating tape is adhered to the end face of the power generating element, the clearance through which the electrolytic solution permeates is present in the end face of the power generating element, unlike the case wherein the central portion of the insulating tape is adhered to the end face of the power generating element so that the end face of the power generating element is covered completely. Hence, the permeation of the electrolytic solution is performed efficiently.

Accordingly, with the first aspect of the present invention, the insulating tapes are not deformed at the time when the power generating element is inserted into the outer package so as to be accommodated therein. Hence, a short circuit between the positive electrode plate and the negative electrode plate owing to a contact between the end face of the power generating element and the inner face of the outer package can be prevented securely.

A second aspect of a nonaqueous electrolyte battery in accordance with the present invention is based on the first aspect, and is characterized in that the end face of the power generating element has a portion to which the insulating tape is not adhered.

In the second aspect of the present invention described above, the end face of the power generating element has a portion to which the insulating tape is not adhered. Hence, the electrolytic solution can permeate through this portion to which the insulating tape is not adhered. Therefore, the permeability of the electrolytic solution is improved, and the electrolytic solution pouring work is carried out efficiently.

Accordingly, with the second aspect of the present invention, the permeability of the electrolytic solution is improved, and the efficiency of the electrolytic solution pouring work is improved.

A third aspect of a nonaqueous electrolyte battery in accordance with the present invention is based on the second aspect, and is characterized in that the portion inside the outer package, being opposed to the insulating tape, is provided with an insulating material.

In the third aspect of the present invention described above, the portion inside the outer package, being opposed to the insulating tape, is also provided with an insulating material. Hence, the portion of the end face to which the insulating tape is not adhered is prevented from being short-circuited to the outer package. The efficiency of the electrolytic solution pouring work can be improved while a short circuit between the end face of the power generating element and the outer package is prevented.

Accordingly, with the third aspect of the present invention, a short circuit between the positive electrode plate and the negative electrode plate owing to a contact between the end face of the power generating element and the inner face of the outer package is prevented securely, and the efficiency of the electrolytic solution pouring work is improved.

A fourth aspect of a nonaqueous electrolyte battery in accordance with the present invention is based on any one of the first through third aspects, and is characterized in that the insulating tape has a base material and an adhesive layer containing an adhesive, and the thickness of the adhesive layer is 10 μm or less, and the thickness of the insulating tape is 15 μm or more and 30 μm or less.

In the fourth aspect of the present invention described above, the insulating tape comprises a base material and an adhesive layer containing an adhesive. The thickness of the adhesive layer is 10 μm or less, and the total thickness of the insulating tape is 15 μm or more and 30 μm or less. Hence, the work for inserting the power generating element into the outer package at the time when the power generating element is accommodated therein is carried out efficiently. In the case that the thickness of the insulating tape is more than 30 μm, the thickness (the width of the end face) of the power generating element increases, whereby the insertion of the power generating element into the outer package becomes difficult. Hence, the thickness of the insulating tape is required to be 30 μm or less. On the other hand, in the case that the thickness of the insulating tape is less than 15 μm, the strength of the insulating tape is lowered, and problems, such as wrinkles, may occur. Hence, the thickness of the insulating tape is required to be 15 μm or more. Furthermore, in the case that the thickness of the adhesive tape is more than 10 μm, problems, such as a problem of allowing the adhesive to ooze out and adhere to the outer package, may occur. Hence, the thickness of the adhesive layer is required to be 10 μm or less.

Accordingly, with the fourth aspect of the present invention, the efficiency of the work for inserting the power generating element, to which the insulating tapes are adhered, into the outer package is improved.

A fifth aspect of a nonaqueous electrolyte battery in accordance with the present invention is based on any one of the first through fourth aspects, and is characterized in that the insulating tape is divided into two parts and adhered so as to be opposed to each other with the end face of the power generating element being held therebetween.

In the fifth aspect of the present invention described above, an insulating tape is divided into two parts and adhered so as to be opposed to each other with the end face of the power generating element being held therebetween. Hence, the work for adhering the two insulating tapes as described above becomes easier than the work for adhering one insulating tape around the circumstance of the end face. In particular, in the case that the insulating tapes are adhered using a machine, the work for adhering two short insulating tapes to both sides of the power generating element in the width direction thereof so as to be opposed to each other becomes easier than the work for adhering one long insulating tape around the circumstance of the end face of the power generating element. At that time, productivity can be improved by simultaneously adhering the two insulating tapes.

Accordingly, with the fifth aspect of the present invention, the insulating tapes can be adhered easily. In particular, in the case that the insulating tapes are adhered using a machine, the configuration of the machine to be used is simplified, and the work is made easier.

A sixth aspect of a nonaqueous electrolyte battery in accordance with the present invention is based on any one of the first through fifth aspects, and is characterized in that the degree of thermal shrinkage of the insulating tape is smaller than the degree of thermal shrinkage of the separator.

In the sixth aspect of the present invention described above, the degree of thermal shrinkage of the insulating tape is smaller than the degree of thermal shrinkage of the separator. Hence, even in the case that the separator shrinks under high temperature environment, the shrinkage of the insulating tape is less than that of the separator. Therefore, the end face of the power generating element does not make contact with the outer package, whereby a short circuit between the positive electrode plate and the negative electrode plate is suppressed.

Accordingly, with the sixth aspect of the present invention, it is possible to suppress a short circuit between the positive electrode plate and the negative electrode plate via the inner face of the outer package at the end face of the power generating element under high temperature environment.

A seventh aspect of a nonaqueous electrolyte battery in accordance with the present invention is based on any one of the first through fifth aspects, and is characterized in that the insulating tape has a thermally activated adhesive layer that develops adhesiveness at a predetermined temperature or more on the face of the base material, the face being opposite to the face on which the adhesive layer is provided.

In the seventh aspect of the present invention described above, a thermally activated adhesive layer that develops adhesiveness at a predetermined temperature or more is provided on the face of the base material of the insulating tape, the face being opposite to the face on which the adhesive layer is provided. Hence, under high temperature environment at the predetermined temperature or higher, the battery swells, and the thermally activated adhesive layer of the insulating tape makes contact with the inner face of the outer package and is adhered thereto. Since the thermally activated adhesive layer of the insulating tape is adhered to the inner face of the outer package as described above, the insulating tape becomes difficult to shrink. This suppresses a short circuit between the positive electrode plate and the negative electrode plate via the inner face of the outer package at the end face of the power generating element owing to the shrinkage of the insulating tape.

Accordingly, with the seventh aspect of the present invention, it is possible to suppress a short circuit between the positive electrode plate and the negative electrode plate via the inner face of the outer package at the end face of the power generating element owing to the shrinkage of the insulating tape under high temperature environment.

An eighth aspect of a nonaqueous electrolyte battery in accordance with the present invention is based on any one of the first through seventh aspects, and is characterized in that the outer package has a bottom face and side walls around the outer circumstance of the bottom face, and the power generating element is accommodated so that the end faces thereof are opposed to the side walls of the outer package.

In the eighth aspect of the present invention described above, the outer package has a bottom face and side walls around the outer circumstance of the bottom face, and the power generating element is accommodated in the outer package so that the end faces of the power generating element are opposed to the side walls of the outer package. Hence, the power generating element is inserted such that the smooth side face portion thereof, having a curved face formed by spirally winding, is directed to the bottom face of the outer package. Therefore, the power generating element is inserted into the outer package smoothly in comparison with the case wherein the power generating element is inserted such that the end face to which the insulating tape is adhered is directed to the bottom face of the outer package, whereby the workability of assembly is improved.

Accordingly, with the eighth aspect of the present invention, it is possible to improve the workability of battery assembly.

The above and further objects and features of the invention will more fully be apparent from the following detailed description with accompanying drawings.

### BRIEF DESCRIPTION OF THE SEVERAL VIEWS OF THE DRAWINGS

FIG. 1A and FIG. 1B are schematic views showing the configuration of an essential portion of a lithium-ion rechargeable battery serving as a nonaqueous electrolyte battery in accordance with the present invention;

FIG. 2 is a schematic perspective view showing a method for adhering insulating tapes to a power generating element in accordance with Embodiment 1;

FIG. 3 is a schematic perspective view showing the method for adhering the insulating tapes to the power generating element in accordance with Embodiment 1;

FIG. 4A and FIG. 4B are schematic views showing the internal configuration of a case;

FIG. 5 is a schematic perspective view showing a method for adhering insulating tapes to a power generating element in accordance with Embodiment 2;

FIG. 6 is a schematic perspective view showing the method for adhering the insulating tapes to the power generating element in accordance with Embodiment 2;

FIG. 7 is a schematic view showing the configuration of an insulating tape having a thermally activated adhesive layer and being used in Embodiment 5;

FIG. 8 is a schematic perspective view showing a method for adhering insulating tapes to a power generating element in accordance with Comparative Example 4;

FIG. 9 is a Table showing results of an oven test, results of an electrolytic solution permeation time measurement and results of a production workability examination of respective Embodiments and Comparative Examples;

FIG. 10 is a Table showing details of types of respective insulating tapes;

FIG. 11 is a perspective view showing a further method for adhering insulating tapes to a power generating element;

FIG. 12 is a perspective view showing the further method for adhering the insulating tapes to a power generating element; and

FIG. 13 is a perspective view showing a still further method for adhering the insulating tapes to a power generating element.

### DETAILED DESCRIPTION OF THE PRESENT INVENTION

The present invention will be described below specifically on the basis of the drawings showing embodiments thereof.

### EMBODIMENT 1

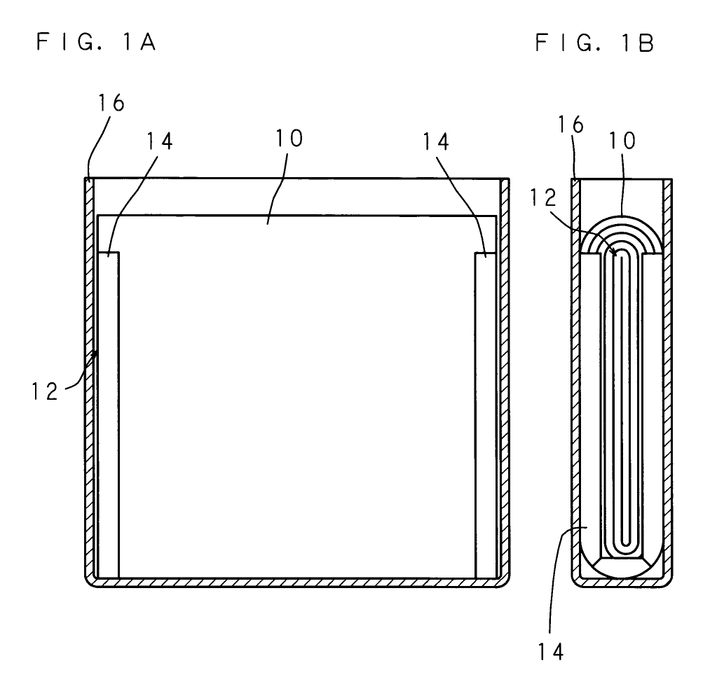

FIG. 1A and FIG. 1B are schematic views showing a configuration of an essential portion of a lithium-ion rechargeable battery as a nonaqueous electrolyte battery in accordance with the present invention. FIG. 1A is a schematic vertical sectional view of a prismatic type lithium-ion rechargeable battery (hereafter simply referred to as a battery) seen from a wider side face (hereafter referred to as the long-side face) thereof. FIG. 1B is also a schematic vertical sectional view of the battery seen from a narrower side face (hereafter, referred to as the short-side face) thereof. As shown in FIG. 1A and FIG. 1B, the battery is configured that a flat-shaped power generating element 10 formed by spirally winding a positive electrode plate and a negative electrode plate with a separator insulated therebetween is accommodated in an aluminum case 16 having a rectangular parallelepiped shape.

The power generating element 10 is accommodated in a state that both end faces 12 thereof are respectively opposed to both the short-side faces of the aluminum case 16 having a rectangular parallelepiped shape. Furthermore, in the case 16, only one face of the six faces constituting the rectangular parallelepiped shape, the upper end portion shown in both of FIG. 1A and FIG. 1B, is open, and the power generating element 10 is inserted from this opening.

The positive mixture is prepared by a process which comprises mixing 90 parts by weight of LiCoO₂ as an active material, 5 parts by weight of acetylene black as a conductive additive and 5 parts by weight of a polyvinylidene fluoride as a binder, and then kneading the mixture properly adding N-methyl-2-pyrrolidone to form a slurry. The slurry thus prepared is uniformly coated on an aluminum collector and then dried. Finally pressing the slurry coated sheet by roll press, the positive electrode plate is completed.

The negative mixture is prepared by a process which comprises mixing 97.0 parts by weight of a carbonaceous material, 1.5 parts by weight of a styrene-butadiene rubber and 1.5 parts by weight of a carboxymethyl cellulose, and kneading the mixture properly adding water to form a slurry. The slurry thus prepared is uniformly coated on the copper collector, and then dried. Finally pressing the slurry coated sheet by roll press, the negative electrode plate is completed.

As the separator, for example, a microporous polyethylene film having a thickness of approximately 20 μm is used. The degree of thermal shrinkage of this kind of separator at 130° C. is 20 to 30% of the degree based on the ordinary temperature. In addition, the electrolyte is 1.1 mol/l LiPF₆ dissolved in a 30/70 mixture (by volume) of ethylene carbonate and ethyl methyl carbonate.

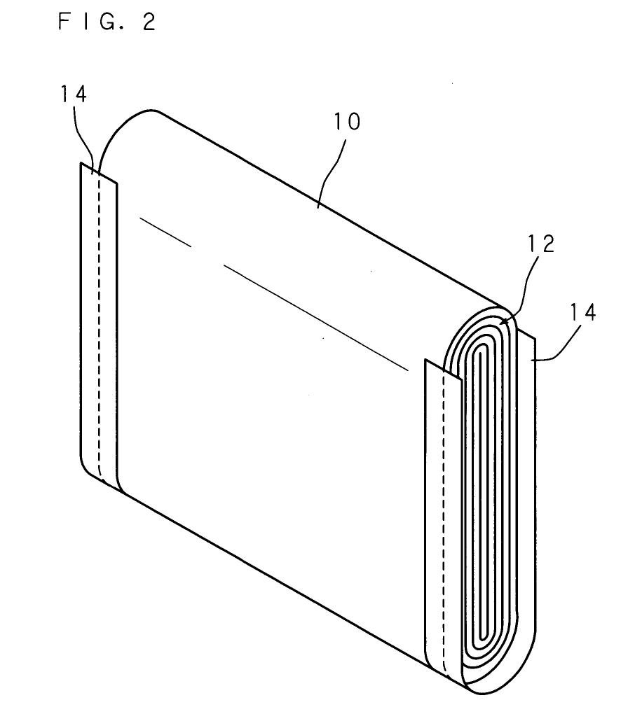

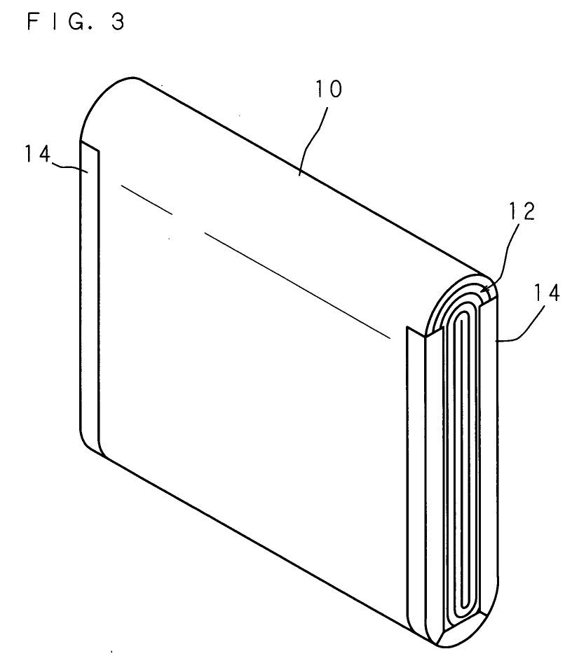

Insulating tapes 14 and 14 are adhered to both end faces 12 and 12 of the power generating element 10 and to the portions of the side faces thereof in the vicinities of the end faces 12. FIG. 2 and FIG. 3 are schematic perspective views showing a method for adhering the insulating tapes 14 to the power generating element in accordance with Embodiment 1. First, as shown in FIG. 2, one insulating tape 14 is adhered to the power generating element 10 in the range from one long-side face of the power generating element 10 to the other long-side face via one short-side face (the lower side in FIG. 2 and FIG. 3) so that the approximate half of the width of the insulating tape 14 protrudes from the end face 12 of the power generating element 10. Next, as shown in FIG. 3, the portion of the insulating tape 14 protruding from the end face 12 of the power generating element 10 is bent and adhered to the end face 12 of the power generating element 10. In the example shown in FIG. 2 and FIG. 3, however, the insulating tape 14 is adhered to a portion (a portion adjacent to the outer fringe) of the end face 12 of the power generating element 10, and the insulating tape 14 is not adhered to the other portion (the central portion) (this method is hereafter referred to as adhering method α). Hence, some portions of both end faces 12 and 12 of the power generating element 10 remain exposed.

The insulating tape 14 comprises a base material and an adhesive layer containing an adhesive. In Embodiment 1, the thickness of the base material is 10 μm, and the thickness of the adhesive layer is 5 μm. Hence, an insulating tape (insulating tape type B) having the total thickness of 15 μm is used. In addition, the degree of thermal shrinkage of the insulating tape 14 is lower than the degree of thermal shrinkage of the separator of the power generating element 10. For example, the degree of thermal shrinkage of the insulating tape 14 at 130° C. is lower than 20 to 30% of the degree of thermal shrinkage of the above-mentioned separator under the same conditions, the degree being based on the ordinary temperature.

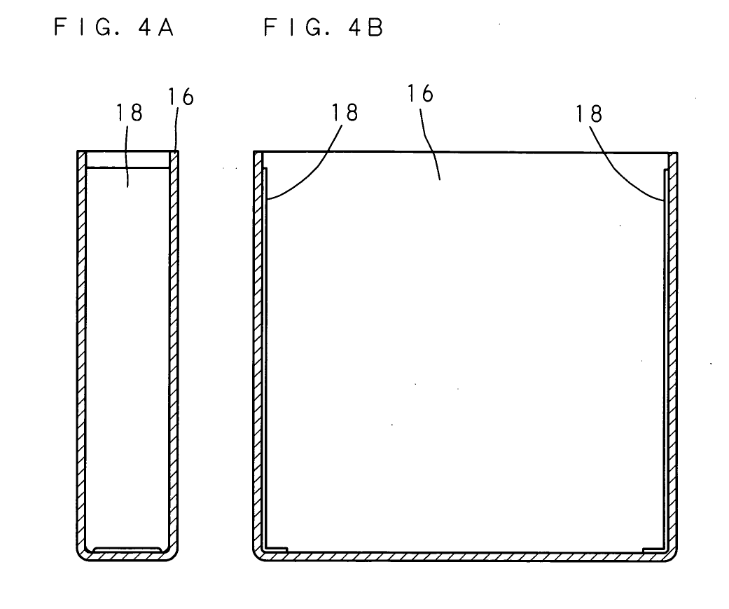

On the other hand, the inner face of the case 16 is also insulated. FIG. 4A and FIG. 4B are schematic views showing an internal configuration of the case 16. FIG. 4A is a schematic vertical sectional view seen from the short-side face of the case 16, and FIG. 4B is a schematic vertical sectional view seen from the long-side face thereof. Insulating sheets (insulating materials) 18 and 18 are adhered to the inner faces of both short-side face portions of the case 16, respectively. In the case that the power generating element 10 is inserted from the opening of the case 16 and accommodated therein, both end faces 12 and 12 of the power generating element 10 face the insulating sheets 18. Therefore, both end faces 12 and 12 of the power generating element 10 are prevented from making contact with (short-circuiting) the inner face of the case 16.

After an electrolytic solution (electrolyte) is poured into the opening (the upper end portion in each of FIG. 1A, FIG. 1B, FIG. 4A and FIG. 4B) of the case 16, a battery lid is laser-welded to the opening, whereby the battery is sealed. The battery lid is provided with a safety valve (not shown) and a negative terminal (not shown) insulated from the battery lid. The negative electrode plate of the power generating element 10 is connected to the negative terminal of the battery lid via a negative lead (not shown), and the positive electrode plate thereof is connected to the case 16 (and the battery lid) via a positive lead (not shown). The battery in accordance with Embodiment 1 measures 30 mm in width, 40 mm in height and 5 mm in thickness, and has a capacity of 800 mAh, for example. Furthermore, in the case that the power generating element 10 is accommodated in the case 16, the clearance between the insulating tape 14 and the inner face of the case 16 (excluding the insulating sheet 18) is 0.35 mm.

### EMBODIMENT 2

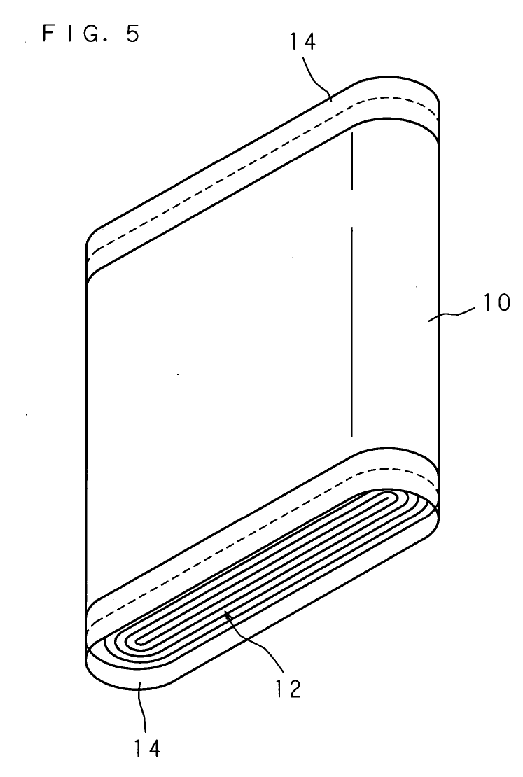

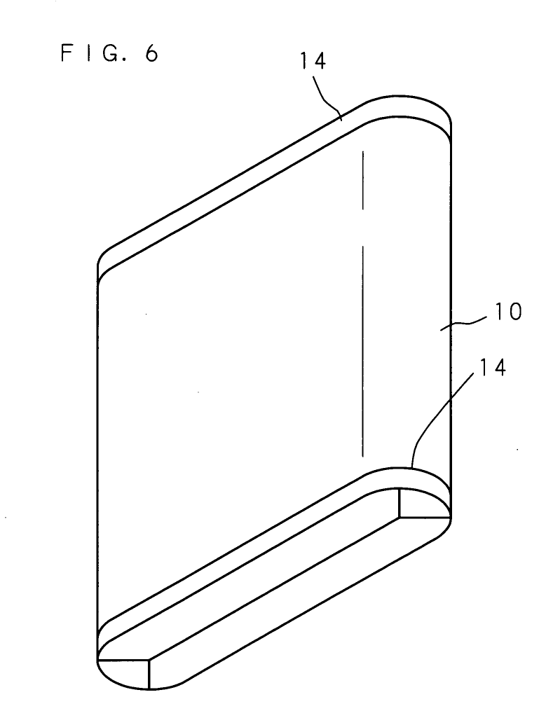

The battery produced in accordance with Embodiment 2 is similar to that in accordance with Embodiment 1 described above, except that the method for adhering the insulating tapes 14 to the power generating element 10 is different and that the insulating sheets 18 are not provided on the inner face of the case 16. FIG. 5 and FIG. 6 are schematic perspective views showing a method for adhering the insulating tapes 14 to the power generating element 10 in accordance with Embodiment 2. First, as shown in FIG. 5, the insulating tape 14 is adhered to the entire circumference of the end face 12 so that the approximate half of the width of the insulating tape 14 protrudes from the end face 12 of the power generating element 10. Next, as shown in FIG. 6, the portion of the insulating tape 14 protruding from the end face 12 of the power generating element 10 is bent and adhered to the end face 12. However, in Embodiment 2, although the insulating tape 14 is adhered so as to cover the whole of the end face 12 of the power generating element 10, the end face 12 is not completely sealed, and there is a clearance enough to allow the electrolytic solution to permeate (this method is hereafter referred to as adhering method B). Hence, in Embodiment 2, since the insulating tape 14 is adhered so as to cover the whole of the end face 12, it is not necessary to provide the insulating sheets 18 in the case 16.

### EMBODIMENT 3

The battery produced in accordance with Embodiment 3 is similar to that in accordance with Embodiment 2 described above, except that an insulating tape (insulating tape type C) comprising a base material having a thickness of 10 μm and an adhesive layer having a thickness of 10 μm, 20 μm in total thickness, is used.

### EMBODIMENT 4

The battery produced in accordance with Embodiment 4 is similar to that in accordance with Embodiment 2 described above, except that an insulating tape (insulating tape type D) comprising a base material having a thickness of 20 μm and an adhesive layer having a thickness of 10 μm, 30 μm in total thickness, is used.

### EMBODIMENT 5

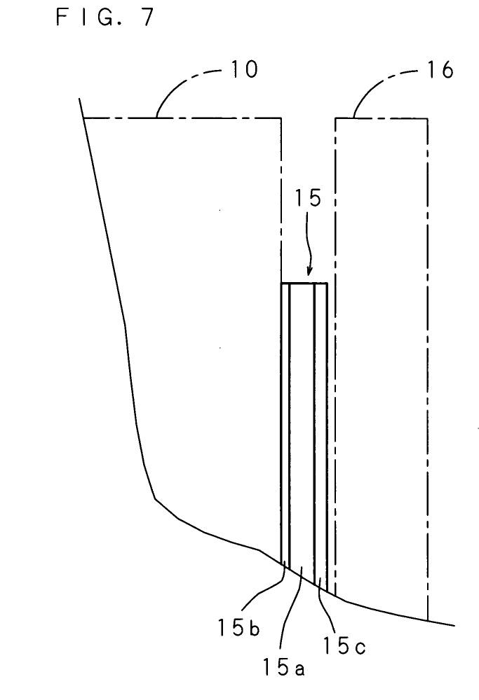

In Embodiment 5, an insulating tape 15 is used in which an adhesive layer 15b is provided on one face (back face) of a base material 15a, and a thermally activated adhesive layer 15c is provided on the other face (front face) of the base material 15a, as shown in FIG. 7, a schematic view showing a configuration example of the insulating tape 15. In the insulating tape 15 being used in Embodiment 5, the thickness of the base material 15a is 10 μm, the thickness of the adhesive layer 15b is 5 μm, and the thickness of the thermally activated adhesive layer 15c is 5 μm. Hence, the total thickness of the insulating tape 15 (insulating tape type B+) is 20 μm. The battery produced in accordance with Embodiment 5 is similar to that in accordance with Embodiment 2 described above, except that this kind of insulating tape 15 is used.

FIG. 7 is a schematic view showing the configuration example of the insulating tape 15 being used in Embodiment 5. The insulating tape 15 adheres to the power generating element 10 by the adhesive layer 15b provided on the back face of the base material 15a, and the thermally activated adhesive layer 15c on the front face of the base material 15a is opposed to the inner face of the case 16 while a slight clearance is usually provided therebetween.

### COMPARATIVE EXAMPLE 1

The battery produced in accordance with Comparative Example 1 is similar to that in accordance with Embodiment 2 described above, except that an insulating tape (insulating tape type A) comprising a base material having a thickness of 5 μm and an adhesive layer having a thickness of 5 μm, 10 μm in total thickness, is used.

### COMPARATIVE EXAMPLE 2

The battery produced in accordance with Comparative Example 2 is similar to that in accordance with Embodiment 2 described above, except that an insulating tape (insulating tape type E) comprising a base material having a thickness of 15 μm and an adhesive layer having a thickness of 15 μm, 30 μm in total thickness, is used.

### COMPARATIVE EXAMPLE 3

The battery produced in accordance with Comparative Example 3 is similar to that in accordance with Embodiment 2 described above, except that an insulating tape (insulating tape type F) comprising a base material having a thickness of 30 μm and an adhesive layer having a thickness of 10 μm, 40 μm in total thickness, is used.

### COMPARATIVE EXAMPLE 4

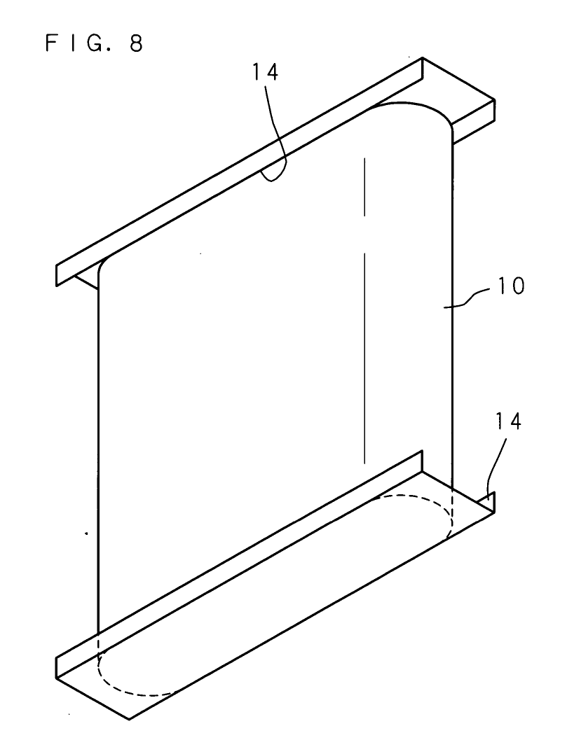

The battery produced in accordance with Comparative Example 4 is similar to that in accordance with Embodiment 2 described above, except for the method for adhering the insulating tape 14. FIG. 8 is a schematic perspective view showing the method for adhering the insulating tapes 14 to the power generating element 10 in accordance with Comparative Example 4, As shown in FIG. 8, first, the central portion of the insulating tape 14, whose width is larger than the width of the end face 12, is adhered to the end face 12 of the power generating element 10. At this time, the insulating tape 14 is adhered so that the longitudinal direction of the end face 12 of the power generating element 10 is aligned with the longitudinal direction of the insulating tape 14. Then, the end portion of the insulating tape 14, protruding from the end face 12 of the power generating element 10, is bent and adhered to the long side faces of the power generating element 10 (this method is hereafter referred to as adhering method γ). Therefore, in Comparative Example 4, both end faces 12 of the power generating element 10 are each completely covered with one insulating tape 14, thereby being almost sealed.

### COMPARATIVE EXAMPLE 5

The battery produced in accordance with Comparative Example 5 is similar to that in accordance with Embodiment 1 described above, except that the insulating tapes 14 are not adhered to the end faces 12 of the power generating element 10 and that the insulating sheets 18 are not provided for the case 16.

The batteries produced as described above in accordance with the respective embodiments and the respective comparative examples were subjected to an oven test, an electrolytic solution permeation time measurement and a production workability examination. In the oven test, the ambient temperature of each battery having been charged up to 4.2 V was raised to 150° C. or 180° C. at a rate of 5° C./minute, and the battery was left at the temperature of 150° C. or 180° C. for 3 hours. The battery was then dismantled, and the insulation between the end face 12 of the power generating element 10 and the inner face of the case 16 was examined visually. In the electrolytic solution permeation time measurement, the time required until 2 g of the electrolytic solution permeated was measured. In the production workability examination, the workability at the time when the power generating element 10 was inserted into the case 16 so as to be accommodated therein was examined.

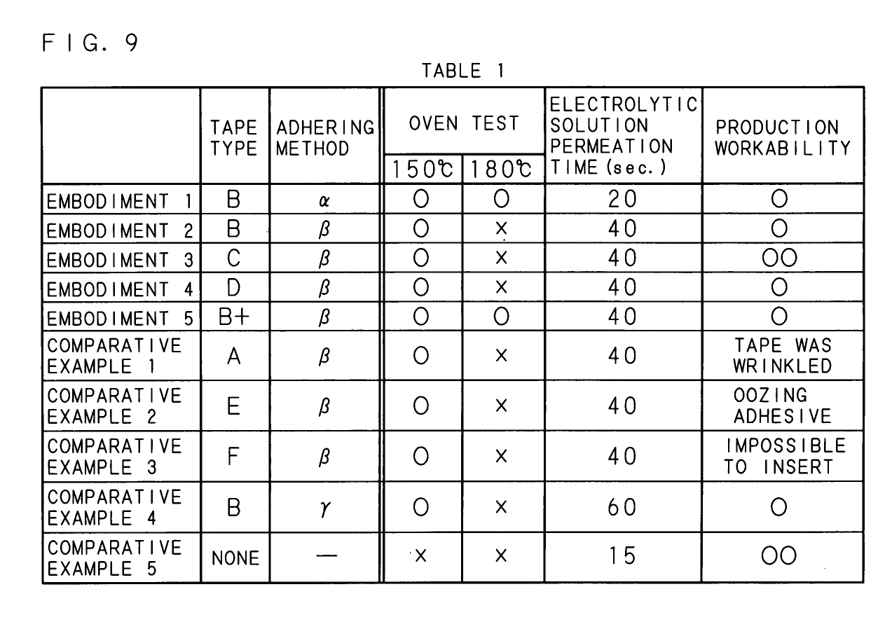

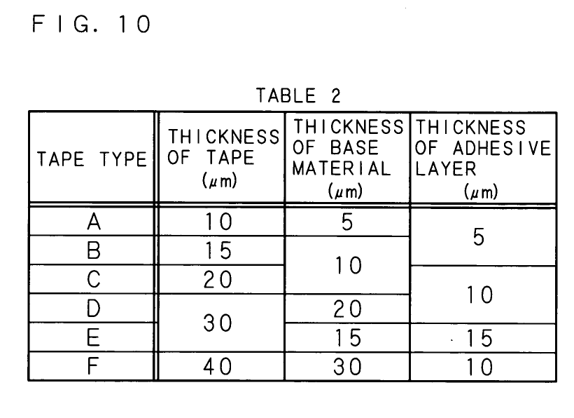

The results of the oven test, the results of the electrolytic solution permeation time measurement and the results of the production workability examination are shown in Table 1 of FIG. 9. The details of the types of the respective insulating tapes described in Table 1 are shown in Table 2 of FIG. 10. In the oven test in Table 1, “O” indicates that the insulation was excellent, and “x” indicates that a short circuit occurred. In addition, in the production workability, “OO” indicates that the workability was excellent, and “O” indicates that the workability is not necessarily excellent but no problem occurred.

Regarding the oven test at 150° C. shown in Table 1, in Embodiment 1 wherein the insulating sheets 18 are provided for the case 16 and in Embodiments 2 to 5 and Comparative Examples 1 to 4 wherein the insulating tape 14 (15) is adhered entirely to the end face 12 of the power generating element 10, the insulation between the end face 12 of the power generating element 10 and the inner face of the case 16 was excellent. Furthermore, even in the case that the separator shrank under high temperature environment, it was possible to maintain the insulation using the insulating tape 14 by making the degree of thermal shrinkage of the insulating tape 14 lower than that of the separator.

In addition, regarding the oven test at 180° C. shown in Table 1, in Embodiment 1 wherein the insulating sheets 18 are provided for the case 16 and in Embodiment 5 wherein the thermally activated adhesive layer 15c is provided on the front face of the base material 15a of the insulating tape 15, the insulation between the end face 12 of the power generating element 10 and the inner face of the case 16 was excellent. On the other hand, in Embodiments 2 to 4 and Comparative Examples 1 to 4, the insulating tape 14 shrunk owing to high temperature. As a result, the inner face of the case 16 made contact with the end face 12 of the power generating element 10, whereby a short circuit occurred between the positive electrode plate and the negative electrode plate. In Embodiment 5, the thermally activated adhesive layer 15c on the front face of the base material 15a of the insulating tape 15 functioned as an adhesive layer at high temperature, and the battery swelled owing to the high temperature. As a result, the thermally activated adhesive layer 15c on the front face of the base material 15a of the insulating tape 15 made contact with the inner face of the case 16, and the insulating tape 15 was adhered to the inner face of the case 16. In Embodiment 5, since the insulating tape 15 was adhered to the inner face of the case 16 as described above, the insulating tape 15 became difficult to shrink, and a short circuit became difficult to occur between the end face 12 and the inner face of the case 16.

Regarding the electrolytic solution permeation time shown in Table 1, the permeation time was the shortest in Comparative Example 5 wherein the insulating tape 14 is not adhered to the end face 12 of the power generating element 10. The permeation time was the next shortest in Embodiment 1 wherein the insulating tape 14 is adhered partly to the end faces 12 of the power generating element 10. In addition, the permeation time was the longest in Comparative Example 4 wherein the central portion of the insulating tape 14 is entirely adhered to the end face 12 and there is almost no clearance through which the electrolytic solution permeates. Furthermore, the permeation time was the next longest in Embodiments 2 to 4 and Comparative Examples 1 to 3 wherein the end portion of the insulating tape 14 is adhered entirely to the end face 12 but there is a clearance through which the electrolytic solution permeates in the end face 12, unlike the case of Comparative Example 4.

In view of the permeability of the electrolytic solution, it is understood that it is preferable that the insulating tape 14 (15) is not adhered entirely to the end face 12 of the power generating element 10. However, in the case that the insulating tape 14 (15) is not adhered entirely to the end face 12, it is necessary to provide the insulating sheet 18 for the case 16. On the other hand, in the case that the insulating tape 14 (15) is adhered entirely to the end face 12, it is not necessary to provide the insulating sheet 18 for the case 16. However, in view of the permeability of the electrolytic solution, it is understood that it is preferable that the insulating tape 14 (15) is adhered so that a clearance through which the electrolytic solution permeates is provided, like the cases of Embodiments 2 to 4 and Comparative Examples 1 to 3.

Regarding the production workability shown in Table 1, in the case of Comparative Example 1 wherein the thickness of the insulating tape 14 is small, the insulating tape 14 was wrinkled. Furthermore, in the case of Comparative Example 3 wherein the thickness of the insulating tape 14 is large, it was impossible to insert the power generating element 10 into the case 16. Hence, it is understood that the thickness of the insulating tape 14 is preferably 15 μm to 30 μm. However, in the case that the thickness of the adhesive layer is large as in the case of Comparative Example 2, there is a fear that the adhesive may ooze out from the fringes of the insulating tape 14 having been bent and adhered to the end face 12 of the power generating element 10. As a result, in this case, the adhesive having oozed out may be adhered to the case 16, machines or the fingers of the workers, whereby the workability is lowered. Hence, it is understood that the thickness of the adhesive layer of the insulating tape 14 is preferably 10 μm or less. However, the thickness of the adhesive layer is required to be 5 μm or more to obtain a satisfactory adhesion effect.

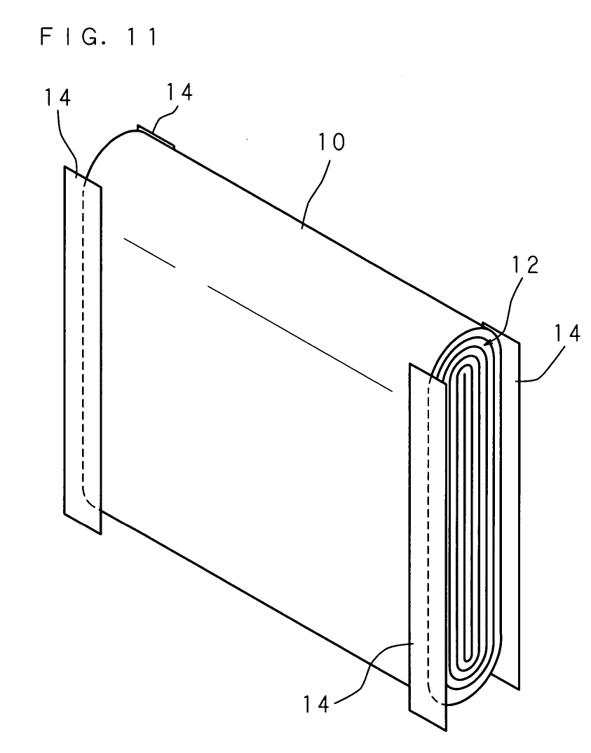

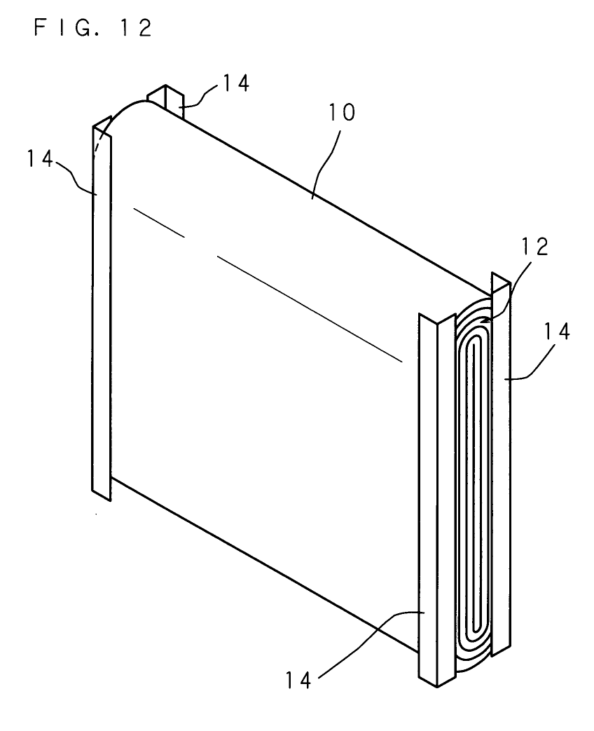

In the adhering method α shown in FIG. 2 and FIG. 3, one tape is adhered in the vicinity of the end portion of the side face of the power generating element 10 so as to be wound around the circumstance of the end face 12 of the power generating element 10. However, it is also possible to adhere two tapes so as to be opposed respectively to the long-side faces on both sides of the end face 12 of the power generating element 10, in the width direction of the end face 12. FIG. 11 and FIG. 12 are schematic perspective views showing a method for adhering the insulating tapes 14 to the power generating element 10 described above. First, as shown in FIG. 11, the two insulating tapes 14 and 14 are adhered respectively to both the long-side faces of the power generating element 10 in the vicinity of the end face 12 so as to be opposed to each other and so that the approximate half of the width of each of the insulating tapes 14 protrudes from the end face 12 of the power generating element 10. Next, as shown in FIG. 12, the portions of the insulating tapes 14 protruding from the end face 12 of the power generating element 10 are bent and adhered to the end face 12.

In the adhering method shown in FIG. 11 and FIG. 12, the two insulating tapes 14 are required for each end face 12 of the power generating element 10. However, it is presumed that the work for adhering the two insulating tapes 14 as described above becomes more simple and easier than the work for adhering one insulating tape 14 around the circumstance of the end face 12 of the power generating element 10. In particular, in the case that the insulating tapes 14 are adhered to the power generating element 10 using a machine, it is presumed that the work for adhering the two insulating tapes 14 to both the long-side faces of the power generating element 10 in the vicinity of the end face 12 so as to be opposed to each other becomes easier than the work for adhering one insulating tape 14 around the circumstance of the end face 12 of the power generating element 10. Accordingly, it is presumed that productivity is improved by simultaneously adhering the two insulating tapes 14 to the power generating element 10.

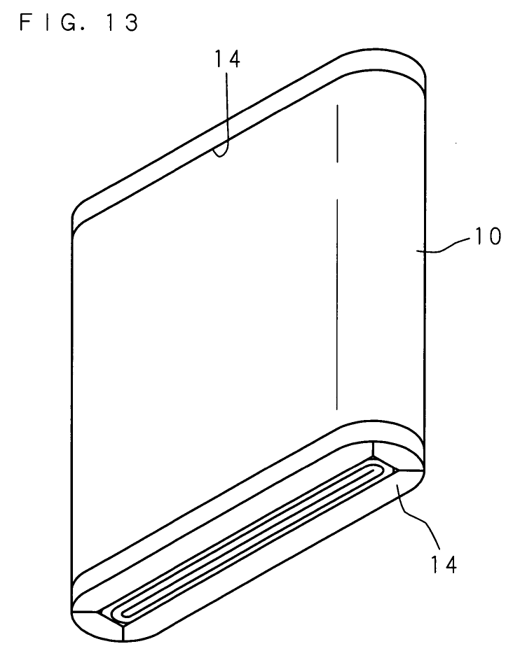

Furthermore, in the case of the adhering method shown in FIG. 6, the insulating tape 14 is adhered to cover the whole of the end face 12 of the power generating element 10. However, as shown in FIG. 13, a perspective view showing a method for adhering the insulating tape 14 to the power generating element 10, it is also possible to adhere the insulating tape 14 so as to cover only a portion (a portion adjacent to the outer fringe) of the end face 12. However, since the insulating tape 14 is not adhered to the central portion of the end face 12 in this case, it is necessary to provide the insulating sheet 18 for the inner face of the case 16, as in the case shown in FIG. 4. As described above, the insulating tape 14 can be adhered so as to cover the whole of the end face 12 or so as to cover a portion thereof, as desired.

The respective embodiments described above are configured that the power generating element 10 is accommodated in the case 16 so that the end face 12 of the power generating element 10 is opposed to the short-side face of the case 16. However, the respective embodiments can also have a constitution wherein the power generating element 10 is accommodated in the case 16 so that the end face 12 of the power generating element 10 is opposed to the bottom face of the case 16. In addition, in the case that the power generating element 10 is inserted into the case 16 so that the end face 12 of the power generating element 10, to which the insulating tape 14 (15) is adhered, is directed to the bottom face of the case 16, it is necessary to exactly position the end face 12 of the power generating element 10 at the opening of the case 16. However, in the case that the power generating element 10 is accommodated in the case 16 in such a way that the smooth portion of the power generating element 10, having a curved face formed by spirally winding the positive electrode plate and the negative electrode plate, is directed to the bottom face of the case 16 so that the end face 12 of the power generating element 10 is opposed to the short-side face of the case 16, the power generating element 10 can be inserted smoothly into the opening without carrying out strict positioning. It is thus needless to say that the workability is improved.

Furthermore, instead of accommodating the power generating element 10 in the case 16 serving as an outer package, it is possible to wind a laminated film around the whole of the power generating element 10 so as to serve as an outer package. Even in the case that the laminated film is used as an outer package, the insulating tapes 14 and 15 can be adhered to the power generating element 10, as in the case that the above-mentioned case 16 is used as an outer package.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds there-of are therefore intended to be embraced by the claims.

1. A nonaqueous electrolyte battery comprising a power generating element formed by spirally winding a positive electrode plate and a negative electrode plate with a separator insulated therebetween, and an outer package for accommodating said power generating element, wherein,
along the winding direction of said positive electrode plate and said negative electrode plate, insulating tapes are adhered to the end faces of said power generating element and to the side faces of said power generating element in the vicinities of the end faces.

2. The nonaqueous electrolyte battery as set forth in claim 1, wherein
said outer package has a bottom face and side walls around the outer circumstance of the bottom face, and
said power generating element is accommodated so that the end faces thereof are opposed to the side walls of said outer package.

3. The nonaqueous electrolyte battery as set forth in claim 1, wherein the degree of thermal shrinkage of said insulating tape is smaller than the degree of thermal shrinkage of said separator.

4. The nonaqueous electrolyte battery as set forth in claim 1, wherein said insulating tape has a thermally activated adhesive layer that develops adhesiveness at a predetermined temperature or more on the face of the base material, said face being opposite to the face on which said adhesive layer is provided.

5. The nonaqueous electrolyte battery as set forth in claim 1, wherein said insulating tape is divided into two parts and adhered so as to be opposed to each other with the end face of said power generating element being held therebetween.

6. The nonaqueous electrolyte battery as set forth in claim 5, wherein the degree of thermal shrinkage of said insulating tape is smaller than the degree of thermal shrinkage of said separator.

7. The nonaqueous electrolyte battery as set forth in claim 5, wherein said insulating tape has a thermally activated adhesive layer that develops adhesiveness at a predetermined temperature or more on the face of the base material, said face being opposite to the face on which said adhesive layer is provided.

8. The nonaqueous electrolyte battery as set forth in claim 1, wherein
said insulating tape has a base material and an adhesive layer containing an adhesive, and
the thickness of said adhesive layer is 10 μm or less, and the thickness of said insulating tape is 15 μm or more and 30 μm or less.

9. The nonaqueous electrolyte battery as set forth in claim 8, wherein said insulating tape is divided into two parts and adhered so as to be opposed to each other with the end face of said power generating element being held therebetween.

10. The nonaqueous electrolyte battery as set forth in claim 9, wherein the degree of thermal shrinkage of said insulating tape is smaller than the degree of thermal shrinkage of said separator.

11. The nonaqueous electrolyte battery as set forth in claim 9, wherein said insulating tape has a thermally activated adhesive layer that develops adhesiveness at a predetermined temperature or more on the face of the base material, said face being opposite to the face on which said adhesive layer is provided.

12. The nonaqueous electrolyte battery as set forth in claim 1, wherein the end face of said power generating element has a portion to which said insulating tape is not adhered.

13. The nonaqueous electrolyte battery as set forth in claim 12, wherein the portion inside said outer package, being opposed to said insulating tape, is provided with an insulating material.

14. The nonaqueous electrolyte battery as set forth in claim 13, wherein
said insulating tape has a base material and an adhesive layer containing an adhesive, and
the thickness of said adhesive layer is 10 μm or less, and the thickness of said insulating tape is 15 μm or more and 30 μm or less.

15. The nonaqueous electrolyte battery as set forth in claim 14, wherein said insulating tape is divided into two parts and adhered so as to be opposed to each other with the end face of said power generating element being held therebetween.

16. The nonaqueous electrolyte battery as set forth in claim 15, wherein the degree of thermal shrinkage of said insulating tape is smaller than degree of thermal shrinkage of said separator.

17. The nonaqueous electrolyte battery as set forth in claim 15, wherein said insulating tape has a thermally activated adhesive layer that develops adhesiveness at a predetermined temperature or more on the face of the base material, said face being opposite to the face on which said adhesive layer is provided.
